(19) United States
(12) Patent Application Publication
(10) Pub. No.: US 2006/0193679 A1
(43) Pub. Date: Aug. 31, 2006

(54) Retractable tube assembly

(76) Inventor: Thomas Lin, Wuci Township (TW)

Correspondence Address: BROWDY AND NEIMARK, P.L.L.C.;624 NINTH STREET, NW, SUITE 300, WASHINGTON, DC, 20001-5303, US

(21) Appl. No.: 11/065,040

(22) Filed: Feb. 25, 2005

(51) Int. Cl. F16B 7/10

(52) U.S. Cl. 403/109.5

(57) ABSTRACT

A retractable tube assembly includes a non-circular inner tube, an elastic locating ring fastened to the bottom end of the inner tube, a rotary actuating member, which has two radially protruding major axis portions and is rotatably mounted inside the elastic locating ring, an outer tube axially slidably coupled to the inner tube, and a rotary knob pivotally coupled to the bottom end of the outer tube and provided with a link inserted into the rotary actuating member for rotating the rotary actuating member between a locking position where the elastic locating ring is peripherally forced against an inside wall of the outer tube to lock the outer tube to the inner tube and an unlocking position where the elastic locating ring is peripherally spaced from the inside wall of the outer tube for enabling the outer tube to be moved axially relative to the inner tube.

### BACKGROUND OF THE INVENTION

1. Field of the Invention

The present invention relates to a retractable tube assembly and more particularly, to a non-circular cross section type retractable tube assembly.

2. Description of the Related Art

FIGS. 9 and 10 show a non-circular cross section type retractable tube assembly 90 according to the prior art. According to this design, the retractable tube assembly 90 comprises an inner tube 91, a locating member 92 fastened to the bottom end of the inner tube 91, an actuating member 93 pivotally fastened to the locating member 92, an eccentric wheel 94 mounted on the actuating member 93, an outer tube 95 axially movably sleeved onto the bottom end of the inner tube 91, a rotary bottom block 96 pivotally fastened to the bottom end of the outer tube 95, and a polygonal rod member 97 fixedly fastened to the bottom block 96 and inserted through the actuating member 93. When the user rotate the rotary bottom block 96, the rod member 97 is drive to rate the actuating member 93, and the eccentric wheel 94 is forced to engage the inside wall of the outer tube 95 or disengage from the inside wall of the outer tube 95, so as to lock the outer tube 95 to the inner tube 91 or to unlock the outer tube 95 from the inner tube 91.

According to the aforesaid design, the eccentric wheel 94 has an oval periphery. When the eccentric wheel 94 is moved to the locking position with two opposite sides of the periphery pressed against the inside wall of the outer tube 95, the contact between the periphery of the eccentric wheel 94 and the inside wall of the outer tube 95 is a line contact that provides a limited friction force. The limited friction force is insufficient to lock the outer tube 95 to the inner tube 91 against exceed external axial force.

### SUMMARY OF THE INVENTION

The present invention has been accomplished under the circumstances in view. It is one object of the present invention to provide a retractable tube assembly, which can conveniently be adjusted to the desired length and positively locks in the adjusted position

To achieve this object of the present invention, the retractable tube assembly comprises an inner tube, an elastic locating, a rotary actuating member, an outer tube and a rotary knob. The inner tube has a non-circular cross section, a top end, and a bottom end. The elastic locating ring is fastened to the bottom end of the inner tube and is substantially in flush with a periphery of the inner tube. The rotary actuating member is mounted inside the elastic locating ring and is rotatable relative to the elastic locating ring between a locking position and an unlocking position. The rotary actuating member has a center through hole axially extending through top and bottom sides thereof and at least one radially protruding major axis portion. The outer tube has a top end sleeved onto the bottom end of the inner tube, a cross section fitting the inner tube, an inside wall facing a periphery of the elastic locating ring, and a bottom end. The rotary knob is pivotally coupled to the bottom end of the outer tube and has a link inserted through the center through hole of the rotary actuating member for rotating the rotary actuating member between the locking position where the elastic locating ring is peripherally forced against the inside wall of the outer tube to lock the outer tube to the inner tube and the unlocking position where the elastic locating ring is peripherally spaced from the inside wall of the outer tube for enabling the outer tube to be moved axially relative to the inner tube.

### BRIEF DESCRIPTION OF THE DRAWINGS

FIG. 1 is a front view of a retractable tube assembly according to a preferred embodiment of the present invention.

FIG. 2 is an exploded view of the retractable tube assembly according to the preferred embodiment of the present invention.

FIG. 3 is a sectional view of the present invention, showing the rotary actuating member rotated to the locking position.

FIG. 4 is a sectional view taken along line 4-4 of FIG. 1, showing the rotary actuating member rotated to the locking position.

FIG. 5 is similar to FIG. 3, but showing the rotary actuating member rotated to the unlocking position.

FIG. 6 is similar to FIG. 4, but showing the rotary actuating member rotated to the unlocking position.

FIG. 7 is a sectional view of a part of the present invention, showing the outer tube moved to the bottom end of the inner tube.

FIG. 8 is a schematic drawing showing an application example of the present invention.

FIG. 9 is an exploded view of a retractable tube assembly according to the prior art.

FIG. 10 is a sectional assembly view of the retractable tube assembly according to the prior art.

### DETAILED DESCRIPTION OF THE INVENTION

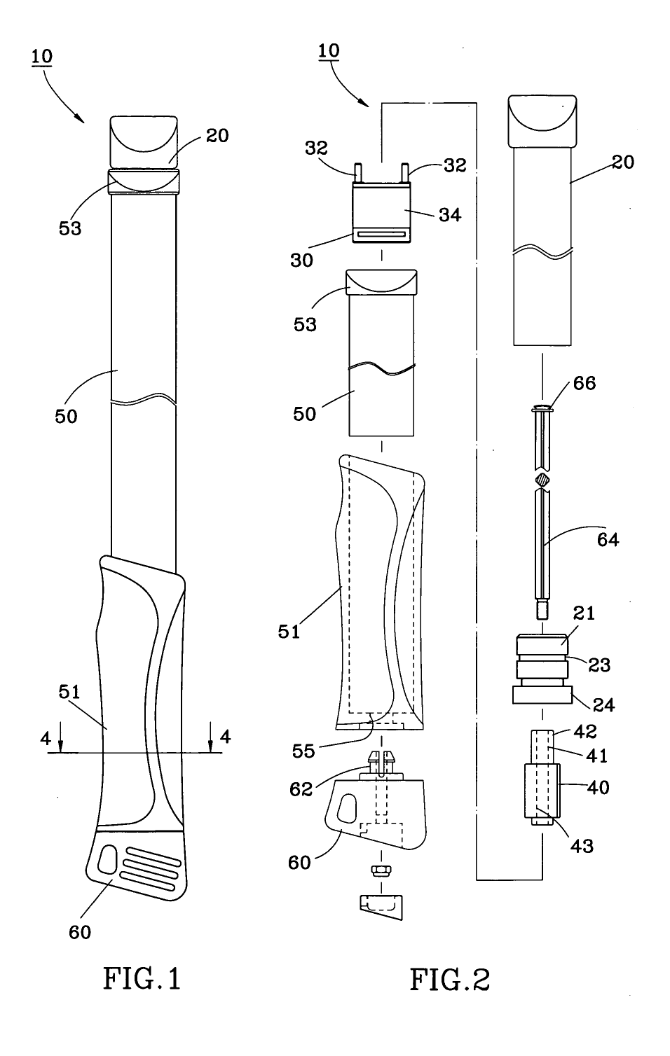

Referring to FIGS. 1-4, a retractable tube assembly 10 in accordance with the preferred embodiment of the present invention is shown comprised of an inner tube 20, a locating ring 30, a rotary actuating member 40, an outer tube 50, and a rotary knob 60.

The inner tube 20 is a non-circular tube having an oval cross section. A plug member 21 is fastened to the bottom end of the inner tube 20. The plug member 21 is a cylindrical member having an oval cross section slightly greater than the inner diameter of the inner tube 20, an axial through hole 22 axially extending through the top and bottom ends thereof, two grooves 23 extending around the periphery at different elevations, and a flange 24 extending around the periphery of the bottom end. By means of the grooves 23, the plug member 21 is compressible. Therefore, the plug member 21 can be press-fitted into the bottom end of the inner tube 20, keeping the flange 24 stopped outside the bottom end of the inner tube 20 in flush with the periphery of the inner tube 20.

The locating ring 30 is an elastic member injection-molded from thermoplastic plastics, having two upright locating rods 32 extending from the top side thereof and a rubber band 34 provided at the periphery thereof. Further, the locating ring 30 has an oval cross section. The two upright locating rods 32 of the locating ring 30 are respectively plugged into a respective bottom hole (not shown) in the bottom side of the plug member 21, keeping the locating ring 30 firmly secured to and abutted against the bottom side of the plug member 21 in flush with the periphery of the plug member 21 and the periphery of the inner tube 20.

The rotary actuating member 40 has a top extension axle 42 axially extending from the top side, a square center through hole 41 axially extending through the top and bottom sides and the top extension axle 42, and two radially protruding major axis portions 43 symmetrically disposed at two sides. The radially protruding major axis portions 43 have a predetermined curvature. The rotary actuating member 40 is mounted in the locating ring 30 with the top extension axle 42 inserted into the axial through hole 22 of the plug member 21. When installed, the rotary actuating member 40 can be rotated relative to the locating ring 30 and the plug member 21 between a locking position, as shown in FIG. 4, and an unlocking position, as shown in FIG. 6. When turned the rotary actuating member 40 to the locking position as shown in FIG. 4, the radially protruding major axis portions 43 are stopped against the inside wall of the locating ring 30 to deform the locating ring 30 and to force the periphery of the locating ring 30 to project outwards at two opposite sides. On the contrary, when turned the rotary actuating member 40 to the unlocking position as shown in FIG. 6, the radially protruding major axis portions 43 are kept spaced from the inside wall of the locating ring 30, and the locating ring 30 returns to its former shape in flush with the periphery of the inner tube 20.

The outer tube 50 has a cross section fitting the inner tube 20. The bottom end of the outer tube 50 is fixedly mounted with a grip 51. The top end of the outer tube 50 is capped with an end cap 53. The grip 51 has a bottom center through hole 55 extending through the bottom wall in communication between the inside space of the outer tube 50 and the outside. The outer tube 50 is sleeved onto one end, namely, the bottom end of the inner tube 20 that is mounted with the locating ring 30, i.e., the locating ring 30 is inserted with the inner tube 20 through the end cap 53 into the inside of the outer tube 50 and axially movable relative to the outer tube 50, keeping the rubber band 34 of the locating ring 30 facing the inside wall of the outer tube 50.

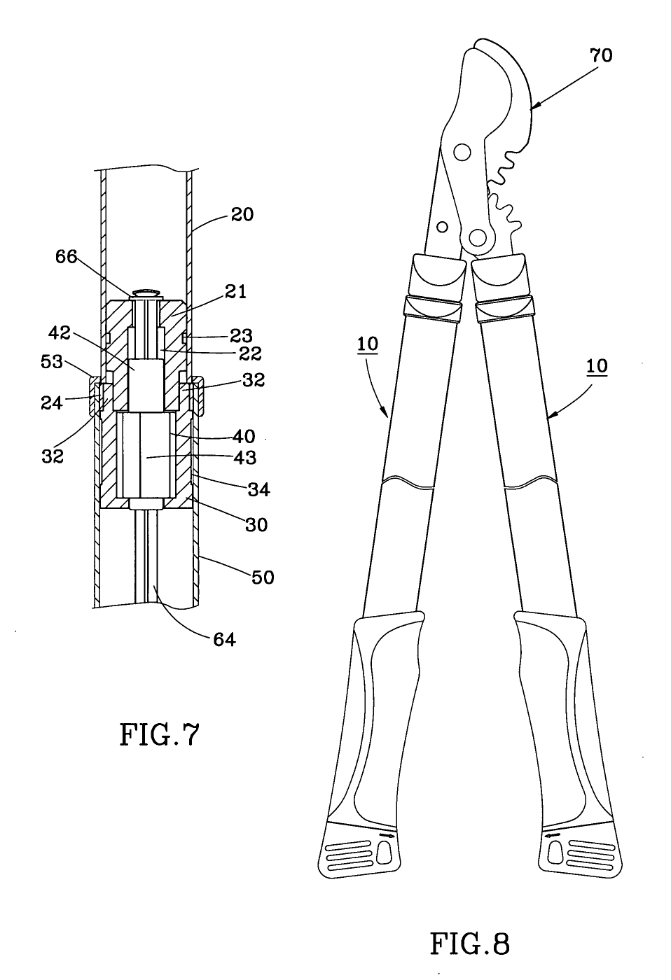

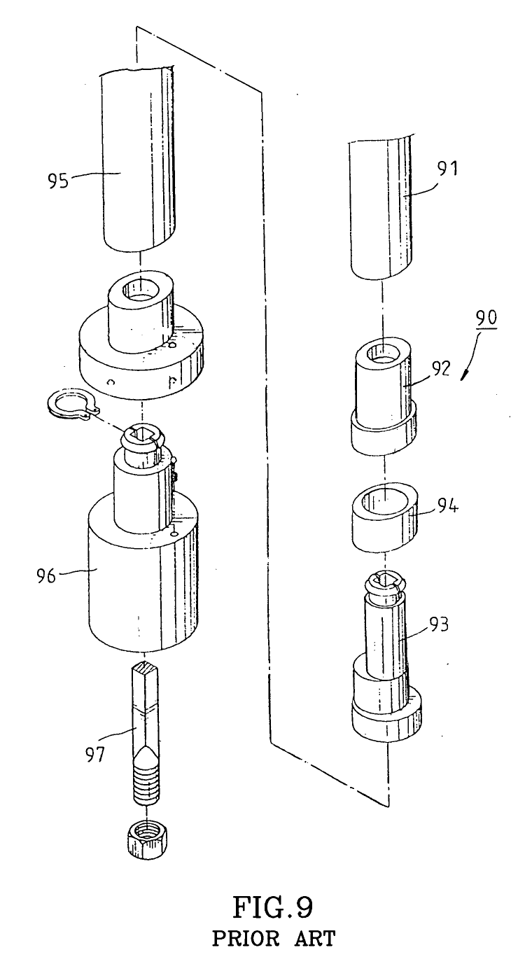

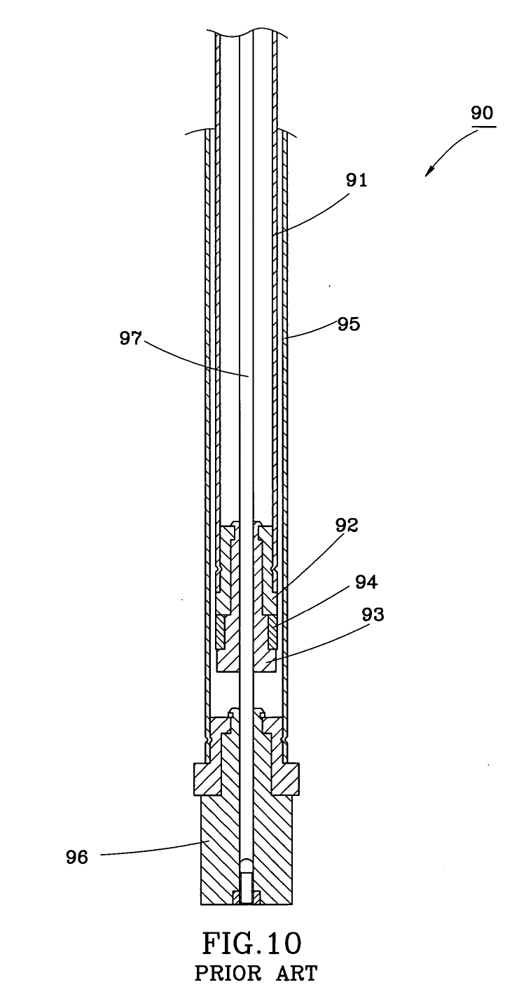

The rotary knob 60 has a tubular split retaining bolt 62 upwardly extending from the top side thereof and pivotally coupled to the through hole 55 of the grip 51, and a link 64 axially extending through the tubular split retaining bolt 62. The cross section of the link 64 fits the cross section of the square center through hole 41 of the rotary actuating member 40. The link 64 has a bottom end inserted through the tubular split retaining bolt 62 and fixedly fastened to the rotary knob 60 through a screw joint, and a top end inserted in proper order through the square center through hole 41 of the rotary actuating member 40 and the axial through hole 22 of the plug member 21 into the inside of the inner tube 20 and the outer tube 50. Further, an end cap 66 is fixedly fastened to the top end of the link 64. When extending the outer tube 50 out of the inner tube 20, the end cap 66 will be stopped at the top side of the plug member 21, preventing separation between the inner tube 20 and the outer tube 50, as shown in FIG. 7.

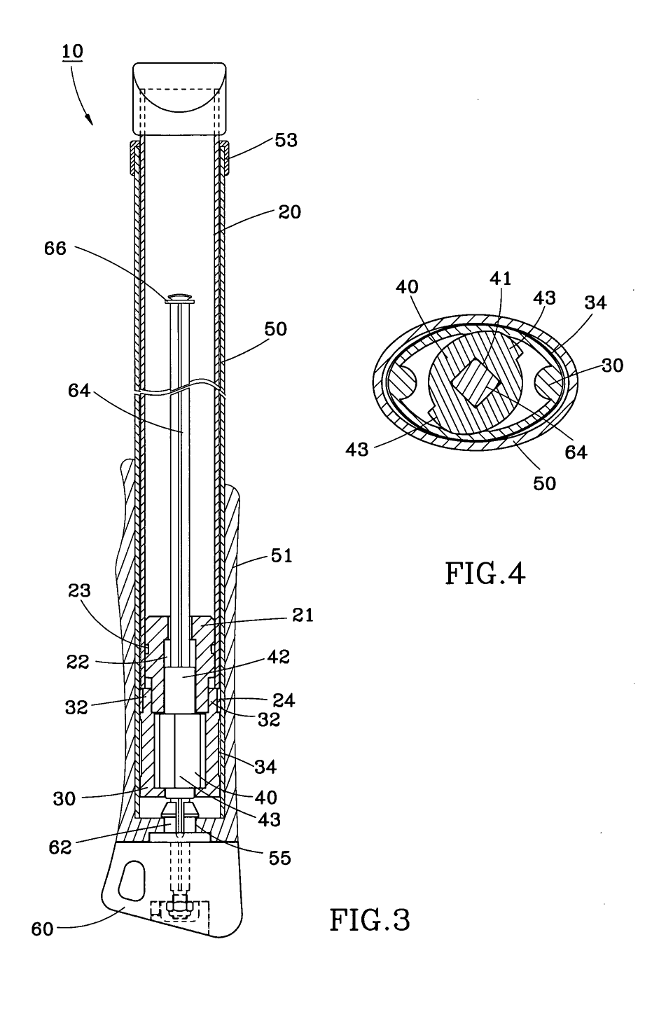

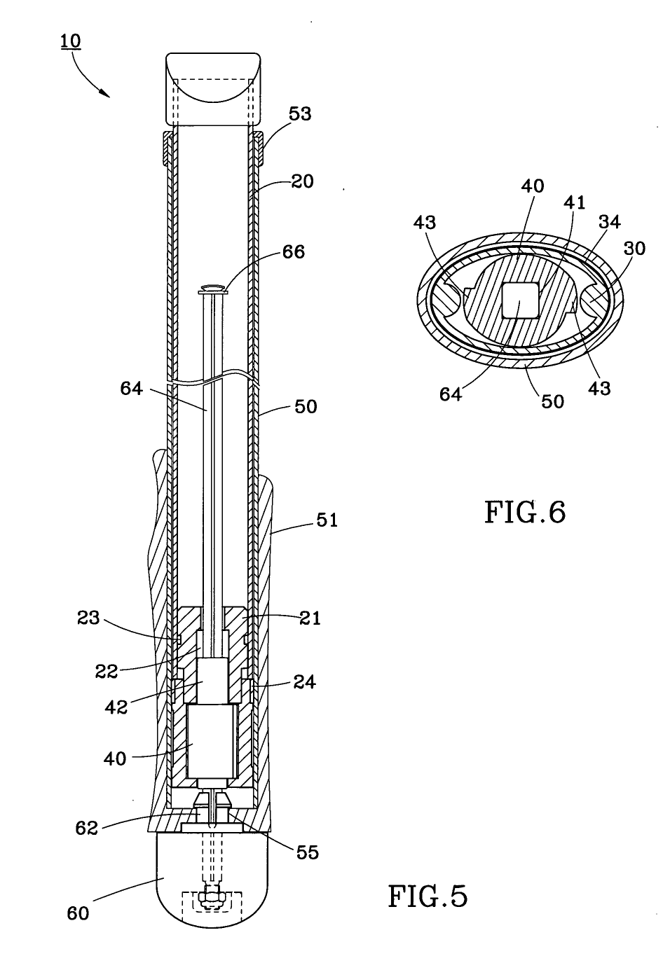

Referring to FIGS. 5 and 6, when wishing to adjust the length of the retractable tube assembly 10, operate the rotary knob 60 to rotate the rotary actuating member 40 to the unlocking position to release the rubber band 34 of the locating ring 30 from the inside wall of the outer tube 50, for enabling the outer tube 50 to be moved axially relative to the inner tube 20 to the desired position. Thereafter, as shown in FIGS. 3 and 4, operate the rotary knob 60 to rotate the rotary actuating member 40 to the locking position where the radially protruding major axis portions 43 of the rotary actuating member 40 are stopped against the inside wall of the locating ring 30 to deform the locating ring 30 and to force the periphery of the locating ring 30 to project outwards at two opposite sides against the inside wall of the outer tube 50, and therefore the outer tube 50 is locked to the inner tube 20. Because the radially 20 protruding major axis portions 43 of the rotary actuating member 40 have a predetermined curvature, the relatively smaller curvature area of each radially protruding major axis portion 43 is used to push the locating ring 30, forcing the rubber band 34 into friction contact with the inside wall of the outer tube 50.

FIG. 8 shows an application example of the present invention. According to this application example, the two handles of the hedge shears 70 are respectively formed of a retractable tube assembly 10. The user can conveniently adjust the length of the handles (retractable tube assemblies 10) of the hedge shears 70 subject to the desired cutting height. When cutting bushes or small trees with the hedge shears 70, the shearing force does not cause relative displacement between the inner tubes 20 and the outer tubes of the retractable tube assemblies 10.

What is claimed is:

1. A retractable tube assembly comprising:
an inner tube having a non-circular cross section, a top end, and a bottom end;
an elastic locating ring, which is fastened to the bottom end of said inner tube and is substantially in flush with a periphery of said inner tube;
a rotary actuating member mounted inside said locating ring and rotatable relative to said locating ring between a locking position and an unlocking position, said rotary actuating member having a center through hole axially extending through top and bottom sides thereof and at least one radially protruding major axis portion;
an outer tube having a top end sleeved onto the bottom end of said inner tube, a cross section fitting said inner tube, an inside wall facing a periphery of said locating ring, and a bottom end; and
a rotary knob pivotally coupled to the bottom end of said outer tube, said rotary knob having a link inserted through the center through hole of said rotary actuating member for rotating said rotary actuating member between said locking position where said locating ring is peripherally forced against the inside wall of said outer tube to lock said outer tube to said inner tube and said unlocking position where said locating ring is peripherally spaced from the inside wall of said outer tube for enabling said outer tube to be moved axially relative to said inner tube.

2. The retractable tube assembly as claimed in claim 1, wherein said locating ring has the periphery thereof provided with a rubber band.

3. The retractable tube assembly as claimed in claim 1, wherein said inner tube has a plug member fastened to the inside of the bottom end thereof, said plug member having a cross section fitting the shape of the cross section of an inner diameter of said inner tube and a center through hole axially extending through top and bottom sides thereof for the passing of said link of said rotary knob; said locating ring is fixedly fastened to said plug member at a bottom side.

4. The retractable tube assembly as claimed in claim 3, wherein the cross section of said plug member is greater than the cross section of the inner diameter of said inner tube; said plug member has two grooves spaced around a periphery thereof at different elevations.

5. The retractable tube assembly as claimed in claim 3, wherein said plug member is press-fitted into the bottom end of said inner tube, having a flange stopped outside the bottom end of said inner tube in flush with the periphery of said inner tube.

6. The retractable tube assembly as claimed in claim 1, wherein said link of said rotary knob has a top end fixedly mounted with an end cap for prohibiting separation between said inner tube and said outer tube during movement of said outer tube relative to said inner tube.

7. The retractable tube assembly as claimed in claim 1, wherein the cross section of the center through hole of said rotary actuating member and the cross section of said link have a rectangular shape.
